(19) United States
(12) Patent Application Publication
(10) Pub. No.: US 2025/0242375 A1
(43) Pub. Date: Jul. 31, 2025

(54) ATOMIZATION DEVICE AND METHOD FOR ASSEMBLING THE SAME

(71) Applicant: SHENZHEN WOODY VAPES TECHNOLOGY CO., LTD., Shenzhen (CN)

(72) Inventors: Yong YANG, Shenzhen (CN); Youming LIU, Shenzhen (CN); Wenlin HUANG, Shenzhen (CN)

(73) Assignee: SHENZHEN WOODY VAPES TECHNOLOGY CO., LTD., Shenzhen (CN)

(21) Appl. No.: 18/901,975

(22) Filed: Sep. 30, 2024

(30) Foreign Application Priority Data
Jan. 31, 2024 (CN) 202410147648.5
Jan. 31, 2024 (CN) 202420248009.3

(51) Int. Cl. B05B 17/00

(52) U.S. Cl. CPC B05B 17/00

(57) ABSTRACT

An atomization device and a method for assembling the same are provided. The atomization device includes an atomization core assembly, a support, and a fixing member. The atomization core assembly includes an atomization-core-assembly body and a lead connected to the atomization-core-assembly body at a bottom of the atomization-core-assembly body. The support has a first mounting surface and a second mounting surface opposite to the first mounting surface, and defines a first mounting hole extending through the first mounting surface and the second mounting surface. The fixing member is connected to the support and configured to fix an end of the lead. The atomization-core-assembly body is connected to the first mounting surface. The lead passes through the first mounting hole and is bent to the first mounting surface or the second mounting surface. The end of the lead is snapped into the fixing member.

### CROSS-REFERENCE TO RELATED APPLICATIONS

This application claims priority under 35 U.S.C. § 119(a) to Chinese Patent Application No. 202410147648.5, filed Jan. 31, 2024, and Chinese Patent Application No. 202420248009.3, filed Jan. 31, 2024, the entire disclosure of which are incorporated herein by reference.

### TECHNICAL FIELD

This disclosure relates to the field of atomization device technology, and in particular to an atomization device and a method for assembling the same.

### BACKGROUND

Existing atomization devices include bodies and atomization core assemblies. At least part of the atomization core assembly is located in an accommodating cavity defined by the body. An air channel is defined in the atomization core assembly. The atomization core assembly can produce aerosol and allow the aerosol to circulate to the external environment through the air channel, so that a user can inhale the aerosol. The atomization core assembly typically has a lead.

The lead of the atomization device is usually fixed by means of interference fit. As a result, during the use of the atomization device, the lead tends to unstable resistance and deformation, so that the atomization core assembly produces aerosol less efficiently, thereby affecting the taste when the user inhales the aerosol.

### SUMMARY

In a first aspect, an atomization device is provided in embodiments of the present disclosure. The atomization device includes an atomization core assembly, a support, and a fixing member. The atomization core assembly includes an atomization-core-assembly body and a lead connected to the atomization-core-assembly body at a bottom of the atomization-core-assembly body. The support has a first mounting surface and a second mounting surface opposite to the first mounting surface, and defines a first mounting hole extending through the first mounting surface and the second mounting surface. The fixing member is connected to the support and configured to fix an end of the lead. The atomization-core-assembly body is connected to the first mounting surface. The lead passes through the first mounting hole and is bent to the first mounting surface or the second mounting surface. The end of the lead is snapped into the fixing member.

In a second aspect, a method for assembling an atomization device is further provided in the present disclosure. The method is applied to the atomization device in the first aspect. The method includes the following. The atomization-core-assembly body is connected to the first mounting surface of the support. The lead is passed through the first mounting hole from the first mounting surface. The lead is bent to the first mounting surface or the second mounting surface. The end of the lead is snapped into the fixing member.

### BRIEF DESCRIPTION OF THE DRAWINGS

To describe the solutions in the present disclosure or in the related art more clearly, the following briefly introduces the accompanying drawings required for describing the embodiments or the related art. Apparently, the accompanying drawings in the following description show merely some embodiments of the present disclosure, and those of ordinary skill in the art may still derive other accompanying drawings from these accompanying drawings without creative efforts.

FIG. 1 is a schematic structural view of an atomization device according to an embodiment of the present disclosure.

FIG. 2 is a schematic structural view of an atomization device according to another embodiment of the present disclosure.

FIG. 3 is an exploded schematic view of the atomization device in FIG. 1.

FIG. 4 is a top view of a support in FIG. 3.

FIG. 5 is a bottom view of a support in FIG. 3.

FIG. 6 is a schematic structural view of the support in FIG. 5.

FIG. 7 is a schematic structural view of assembly of an atomization core assembly and a support in FIG. 3.

FIG. 8 is a schematic structural view of assembly of an atomization core assembly, a base, an electrode, and a support in FIG. 3.

FIG. 9 is a schematic structural view of a support according to another embodiment in FIG. 3.

FIG. 10 is a schematic structural view of a sealing member in FIG. 3.

FIG. 11 is a cross-sectional view of the atomization device in FIG. 1.

FIG. 12 is a schematic structural view of the atomization device in FIG. 11 when atomized liquid is added.

FIG. 13 is a schematic view of an internal structure of an atomization device according to an embodiment of the present disclosure.

FIG. 14 is a flowchart of a method for assembling an atomization device according to an embodiment of the present disclosure.

FIG. 15 is a flowchart of a method for assembling an atomization device according to another embodiment of the present disclosure.

Reference signs in the accompanying drawings are described as follows: atomization device 10, infusion member 20, housing 100, elastic injection plug 111, fixing portion 112, flipping portion 113, first injection hole 120, sealing member 200, limiting portion 210, protruding portion 220, sealing-member body 230, fixing hole 231, injection gap 240, first elastic protrusion 250, second elastic protrusion 260, atomization core assembly 300, atomization-core-assembly body 310, second injection hole 311, flow channel 312, inhalation channel 313, lead 320, support 400, support body 410, first mounting surface 411, second mounting surface 412, first mounting hole 420, limiting notch 421, fixing member 430, connecting portion 431, bending portion 432, transitional edge 435, limiting groove 433, bending gap 434, third mounting hole 440, avoidance notch 450, guiding portion 460, guiding surface 461, guiding channel 470, first sidewall 480, second sidewall 490, liquid absorbent fiber 500, first liquid-absorbent-fiber 510, second liquid-absorbent-fiber 520, base 600, second mounting hole 601, liquid reservoir 610, electrode 700.

### DETAILED DESCRIPTION

Unless otherwise defined, all technologies and scientific terms used in the present disclosure have common meanings that are able to be understood by those skilled in the art. All terms used in the present disclosure are only for the purpose of illustrating specific embodiments, but are not intended to limit the present disclosure. Terms “comprising”, “including”, “having” and any variants thereof are intended to cover non-exclusive inclusions. Terms “first”, “second”, etc., in the specification and claims of the present disclosure and the above accompanying figures are used to distinguish different objects, but are not used to describe a specific order.

Specific features, structures, and characteristics, which are mentioned in the present disclosure, may be included in at least one embodiment. Phrases in the present disclosure are not necessary to refer to the same embodiment and do not refer to an independent embodiment and an alternative embodiment which are exclusive to other embodiments. It may be explicitly and implicitly understood by those skilled in the art that embodiments described in the present disclosure may be combined with other embodiments.

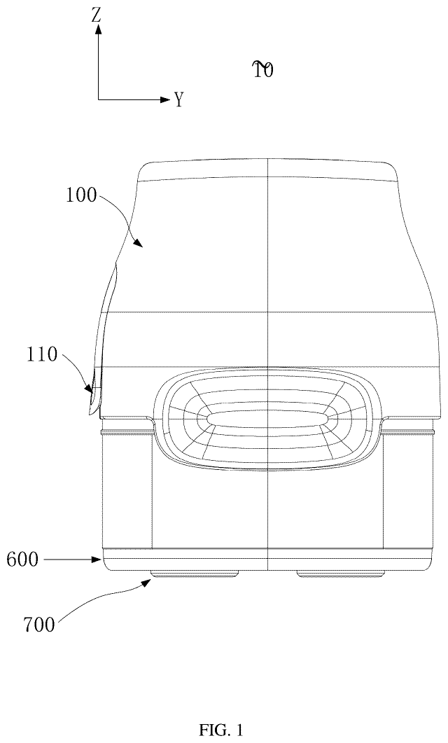

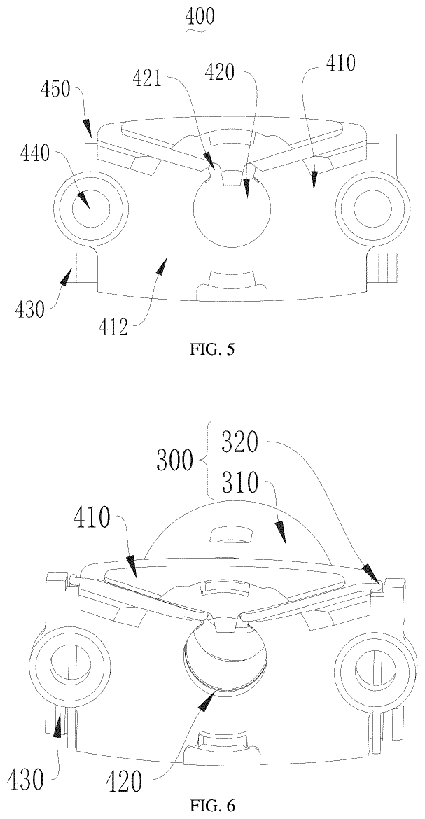

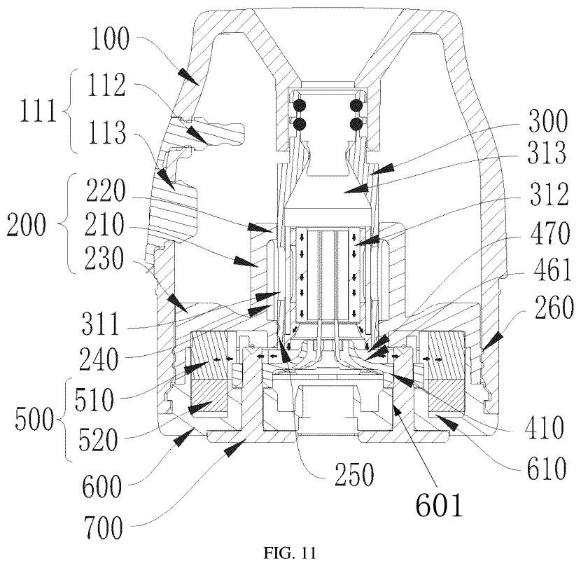

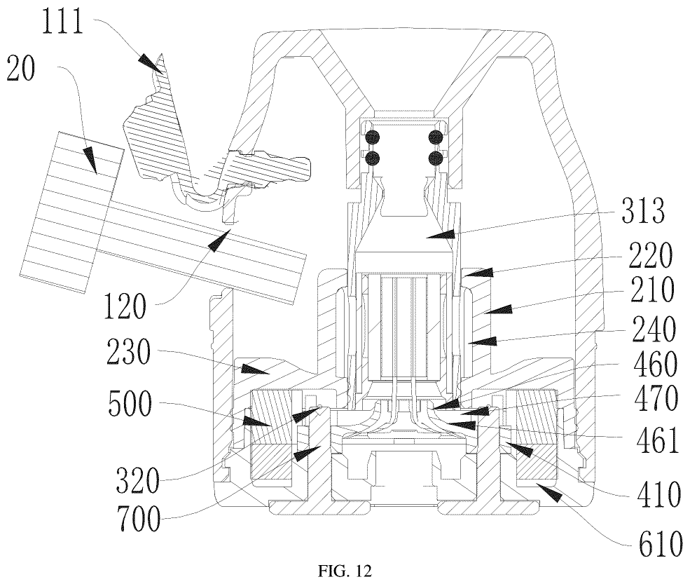

In some embodiments, referring to FIG. 1 to FIG. 9, and FIG. 11 to FIG. 12.

The atomization device 10 includes an atomization core assembly 300, a support 400, and a fixing member 430. The atomization core assembly 300 includes an atomization-core-assembly body 310 and a lead 320 connected to the atomization-core-assembly body 310 at a bottom of the atomization-core-assembly body 310. The support 400 has a first mounting surface 411 and a second mounting surface 412 opposite to the first mounting surface 411, and defines a first mounting hole 420 extending through the first mounting surface 411 and the second mounting surface 412. The fixing member 430 is connected to the support 400 and configured to fix an end of the lead 320. The atomization-core-assembly body 310 is connected to the first mounting surface 411. The lead 320 passes through the first mounting hole 420 and is bent to the first mounting surface 411 or the second mounting surface 412. The end of the lead 320 is snapped into the fixing member 430.

Firstly, the atomization-core-assembly body 310 can be connected to the first mounting surface 411, and covers the first mounting hole 420. Referring to FIG. 6 to FIG. 8, the lead 320 passes through the first mounting hole 420 from the first mounting surface 411 to the second mounting surface 412. After the lead 320 passing through the first mounting hole 420, the lead 320 is bent for the first time to be attached to the second mounting surface 412. Alternatively, after the lead 320 passes through the first mounting hole 420, the lead 320 is bent for the first time to be attached to the second mounting surface 412, and then the lead 320 is bent for the second time and bent for the third time, so as to reach the first mounting surface 411. The above two types of mounting positions of the lead 320 can both ensure the attachment between the lead 320 and the support 400, thereby fixing the lead 320 to a certain extent.

Secondly, after the lead 320 is bent to the first mounting surface 411 or the second mounting surface 412, the end of the lead 320 may still shake. Therefore, the fixing member 430 is further disposed in this embodiment. The end of the lead 320 is snapped into the fixing member 430. The end of the lead 320 may be understood as an end of the lead 320 away from the atomization-core-assembly body 310. Thus, the lead 320 is limited in position by an inner wall of the first mounting hole 420, a surface of the support 400, and the fixing member 430 together. Therefore, the lead 320 does not need to rely on the interference fit in the related art, so that a surface of the lead 320 is prevented from being continuously subjected to a relatively large pressure. Thus, the lead 320 has a stable structure, is not easy to be displaced or deformed, and has stable resistance.

Finally, in the related art, the structure of the atomization core assembly and the support determines that the atomization core assembly and the support are usually mounted independently. That is, the atomization core assembly and the support need to be successively mounted at different positions in the atomization device, and connected to different structures. Therefore, after the atomization device in the related art operates for a certain period of time, the atomization core assembly and the support are easy to be misplaced or loosened with each other, thereby shortening the service life of the atomization device. In addition, due to the structure limit of the atomization core assembly and the support, the atomization core assembly and the support need to be mounted independently, and thus standardization cannot be met in the mounting process of the atomization core assembly and the support. In other words, a mounting error is easy to occur, resulting in the misplacement of the atomization core assembly and the support in position, and further resulting in low assembly efficiency and low yield of the atomization device as a whole, and also resulting in increased labor costs.

In the atomization device 10 of this embodiment, for the atomization core assembly 300 and the support 400, the lead 320 is connected to the fixing member 430, and the atomization-core-assembly body 310 is connected to the first mounting surface 411. In this connecting manner, the atomization core assembly 300 and the support 400 can form a whole, that is, the atomization core assembly 300 and the support 400 can be assembled first and then be assembled with other components. In this assembly manner, the error can be effectively avoided after the atomization core assembly 300 and the support 400 are respectively mounted on other structures, and modular assembly and automatic assembly of the atomization core assembly 300 and the support 400 are realized, thereby improving the assembly efficiency and the yield of the atomization core assembly 10, and saving labor costs. Meanwhile, due to the connection between the lead 320 and the fixing member 430, the atomization core assembly 300 is very stably connected to the support 400, and the atomization core assembly 300 and the support 400 are not easy to be loosened or displaced with each other, so that the stability and service life of the atomization device 10 are also significantly improved.

It may be understood that, when the lead 320 is bent continuously to the first mounting surface 411, the lead 320 can be prevented from being clamped and deformed by the base 600 and the support 400. Meanwhile, since the lead 320 bypasses an outer sidewall of the support 400, which is equivalent that the lead 320 wraps the support 400, the stability is stronger. The fixing member 430 may be integrally formed with the support 400 or be detachably connected to the support 400.

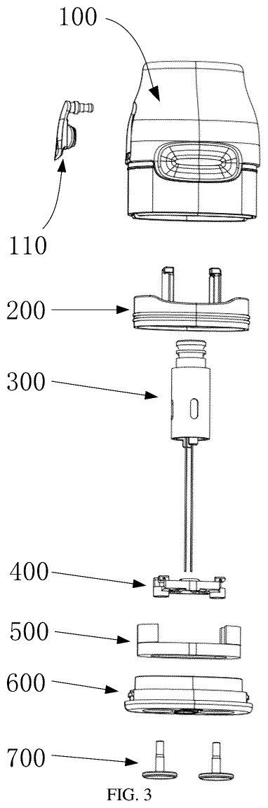

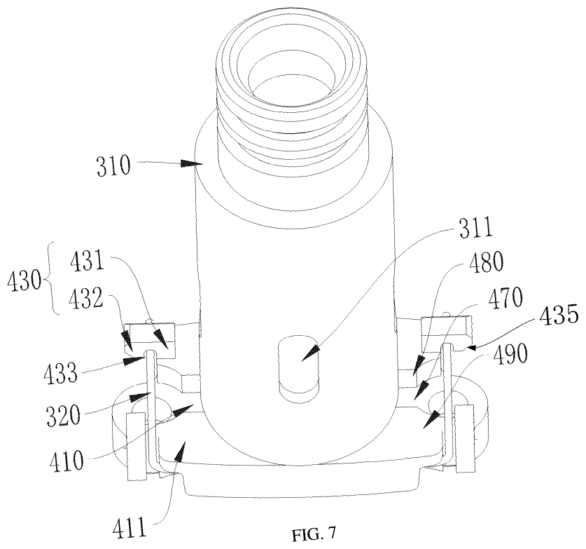

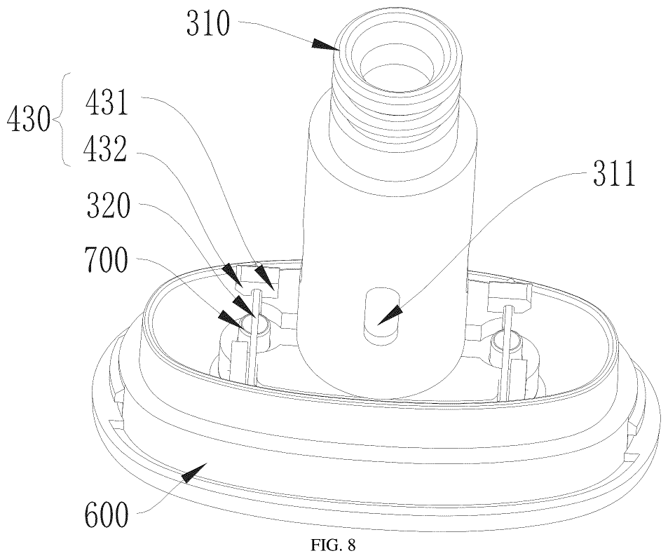

Further, referring to FIG. 3, and FIG. 7 to FIG. 9, the fixing member 430 includes a connecting portion 431 and a bending portion 432. The connecting portion 431 has one end connected to the support 400, and the other end connected to the bending portion 432. A bending gap 434 is defined between the bending portion 432 and the support 400. The bending portion 432 defines a limiting groove 433 on a surface of the bending portion 432 facing the bending gap 434. The end of the lead 320 is snapped into the limiting groove 433.

After the lead 320 is bent to the side at which the fixing member 430 is located, the lead 320 can also be bent into the bending gap 434. Then, since the lead 320 itself has a certain elasticity, the lead 320 can be elastically deformed and naturally snapped into the limiting groove 433. Alternatively, when the lead 320 is not elastic enough, the lead 320 can be snapped into the limiting groove 433 manually. In this case, the limiting groove 433 can fix the end of the lead 320, thereby preventing the lead 320 from shaking.

Further, referring to FIG. 3, and FIG. 7 to FIG. 9, at one side of the bending portion 432 away from the connecting portion 431, the bending portion 432 has a transitional edge 435 between two faces of the bending portion 432. The transitional edge 435 may be a chamfer or a rounded corner. For example, the bending portion 432 has a chamfer at one side of the bending portion 432 away from the connecting portion 431. The chamfer extends to the bending gap 434. Alternatively, the bending portion 432 has a rounded corner at one side of the bending portion 432 away from the connecting portion 431. The rounded corner extends to the bending gap 434. Since the chamfer is defined at one side of the bending portion 432 away from the connecting portion 431, the chamfer can guide the lead 320 when the bending portion 432 is guided and bent into the bending gap 434, thereby improving the mounting efficiency of the lead 320. Meanwhile, the chamfer or the rounded corner can also avoid the damage to the lead 320 due to bumping against an edge of the bending portion 432, thereby improving the yield of the atomization device 10.

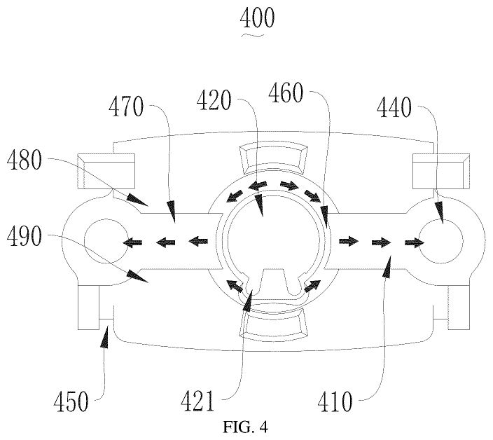

Further, referring to FIG. 4 to FIG. 6, a sidewall of the first mounting hole 420 defines a limiting notch 421. The limiting notch 421 matches the lead 320 in shape and size. At least part of the lead 320 is snapped into the limiting notch 421.

In this embodiment, that the limiting notch 421 matches the lead 320 in shape and size may be understood that after part of the lead 320 is located in the limiting notch 421, the part of the lead 320 located in the limiting notch 421 is fixed and unable to shake. In this case, the sidewall of the first mounting hole 420 defines the limiting notch 421, the limiting notch 421 matches the lead 320 in shape and size, and the part of the lead 320 located at the limiting notch 421 is fixed. Therefore, the stability of the lead 320 is stronger, and the lead 320 can be prevented from shaking during mounting, thereby improving the production efficiency of the atomization device 10.

Further, referring to FIG. 3 to FIG. 9, there are at least two fixing members 430, at least two leads 320, and at least two limiting notches 421. The number of (that is, the quantity of) the at least two fixing members 430 is equal to the number of the at least two leads 320. The number of the at least two limiting notches 421 is equal to the number of the at least two leads 320. The at least two fixing members 430 are uniformly distributed in a circumferential direction of the first mounting hole 420. The at least two limiting notches 421 are uniformly distributed in the circumferential direction of the first mounting hole 420.

When there are multiple leads 320, there may also multiple fixing members 430 and multiple limiting notches 421, thereby realizing one-to-one corresponding fixing of the leads 320, and accordingly improving the stability of the leads 320. Meanwhile, since the fixing members 430 are uniformly distributed in the circumferential direction of the first mounting hole 420, and the limiting notches 421 are uniformly distributed in the circumferential direction of the first mounting hole 420, the support 400 and the atomization-core-assembly body 310 are uniformly subjected to force, and the structural strength and stability of the support 400 and the atomization-core-assembly body 310 are improved.

Further, referring to FIG. 4 to FIG. 6, an outer sidewall of the support 400 defines an avoidance notch 450. At least part of the lead 320 is accommodated in the avoidance notch 450 and is bent to the first mounting surface 411.

That the at least part of the lead 320 is accommodated in the avoidance notch 450 may be understood that at least part of the lead 320 in a length direction of the lead 320 is located in the avoidance notch 450 and completely located in the avoidance notch 450.

When the lead 320 needs to be bent to the first mounting surface 411, the lead 320 needs to bypass the outer sidewall of the support 400. In this case, it is equivalent that the lead 320 exceeds the outer sidewall of the support 400, and thus the lead 320 is easily damaged by bumping against other components inside the atomization device 10. To avoid damage to the lead 320, the avoidance notch 450 is defined in this embodiment, and the avoidance notch 450 can accommodate the lead 320 therein. In this case, the lead 320 no longer exceeds the outer sidewall of the support 400, thereby avoiding bumping damage of the lead 320.

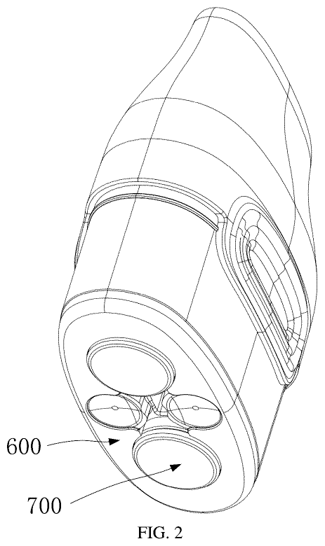

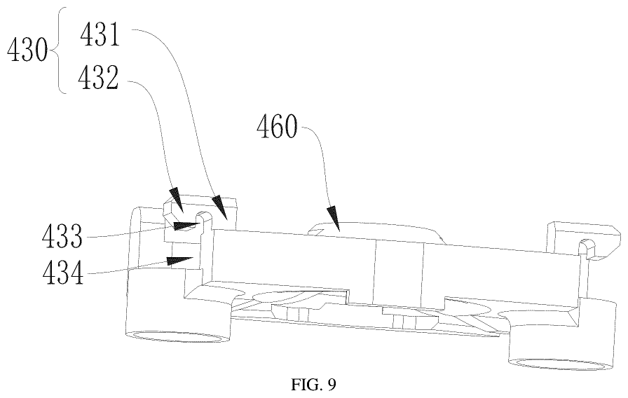

Further, referring to FIG. 2, FIG. 3, FIG. 9, FIG. 11, and FIG. 12, the atomization device 10 further includes a base 600 and an electrode 700. The support 400 is connected to the base 600. The atomization-core-assembly body 310 is located at one side of the support 400 away from the base 600. The base 600 defines a second mounting hole 601. The electrode 700 passes through the second mounting hole 601, and has one end connected to the lead 320.

Further, referring to FIG. 2, FIG. 3, FIG. 9, FIG. 11, and FIG. 12, the lead 320 is bent to the first mounting surface 411 or the second mounting surface 412. The support 400 further defines a third mounting hole 440 in a circumferential direction of the first mounting hole 420. A projection of at least part of the lead 320 on the first mounting surface 411 or the second mounting surface 412 is located in the third mounting hole 440. The second mounting hole 601 is coaxial with the third mounting hole 440. The electrode 700 passes through the third mounting hole 440.

For example, the lead is bent to the first mounting surface 411. When the electrode 700 is mounted, the electrode 700 can be quickly passed through the second mounting hole 601 to the third mounting hole 440, and the electrode 700 is made to abut against the lead 320. Therefore, there is no need to manually move the lead 320 or the electrode 700 to perform position matching of the lead 320 and the electrode 700, thereby improving the production efficiency of the atomization device 10.

The lead 320 needs to be connected to the electrode 700 to implement an electrical operation of the atomization core assembly 300. When the end of the lead 320 in this embodiment is located on the second mounting surface 412, the electrode 700 may directly abut against the lead 320. When the end of the lead 320 is bent to the first mounting surface 411, the electrode 700 can pass through the support 400 and abut against the lead 320.

It can be understood that the atomization-core-assembly body 310 may be connected to the support 400 through the first mounting hole 420. In this case, the bottom of the atomization-core-assembly body 310 can be in communication with the first mounting hole 420, and an airflow can flow into the atomization-core-assembly body 310 through the first mounting hole 420. In other words, the first mounting hole 420 plays a role of guiding gas and allowing circulation of the gas. The atomization-core-assembly body 310 may also be connected to the support 400 through other parts of the support 400. For example, the support 400 has a local protrusion that forms a snapped connection with a sidewall of the atomization-core-assembly body 310. When the atomization-core-assembly body 310 is connected to the support 400 not through the first mounting hole 420, the first mounting hole 420 and the atomization-core-assembly body 310 may be arranged in a staggered manner, and the first mounting hole 420 do not undertake the guide and circulation functions of gas.

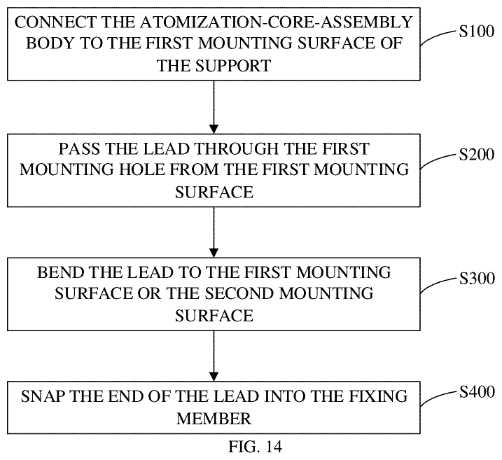

Accordingly, referring to FIG. 14, a method for assembling an atomization device 10 is further provided in the present disclosure. The method is applied to the atomization device 10 in the described embodiments. The method includes the following.

S100, the atomization-core-assembly body 310 is connected to the first mounting surface 411 of the support 400.

S200, the lead 320 is passed through the first mounting hole 420 from the first mounting surface 411.

S300, the lead 320 is bent to the first mounting surface 411 or the second mounting surface 412.

S400, the end of the lead 320 is snapped into the fixing member 430.

The atomization-core-assembly body 310 can be connected to the first mounting surface 411, and the atomization-core-assembly body 310 covers the first mounting hole 420. Referring to FIG. 6 to FIG. 8, the lead 320 is passed through the first mounting hole 420 from the first mounting surface 411 to the second mounting surface 412. The lead 320 is bent for the first time after passing the lead 320 through the first mounting hole 420, to be attached to the second mounting surface 412. Alternatively, after the lead 320 passes through the first mounting hole 420, the lead 320 is bent for the first time to be attached to the second mounting surface 412, and then the lead 320 is bent for the second time and bent for the third time, so as to reach the first mounting surface 411. The above two types of mounting positions of the lead 320 can both ensure the attachment between the lead 320 and the support 400, thereby fixing the lead 320 to a certain extent.

After the lead 320 is bent to the first mounting surface 411 or the second mounting surface 412, a fixing member 430 is further disposed in this embodiment, and an end of the lead 320 is snapped into the fixing member 430. Therefore, when the atomization device 10 in the described embodiments is assembled, by the method in the present disclosure, the efficiency of the atomization device 10 can be improved, and the lead 320 of the atomization device 10 finally assembled has stable resistance and is not easy to be deformed.

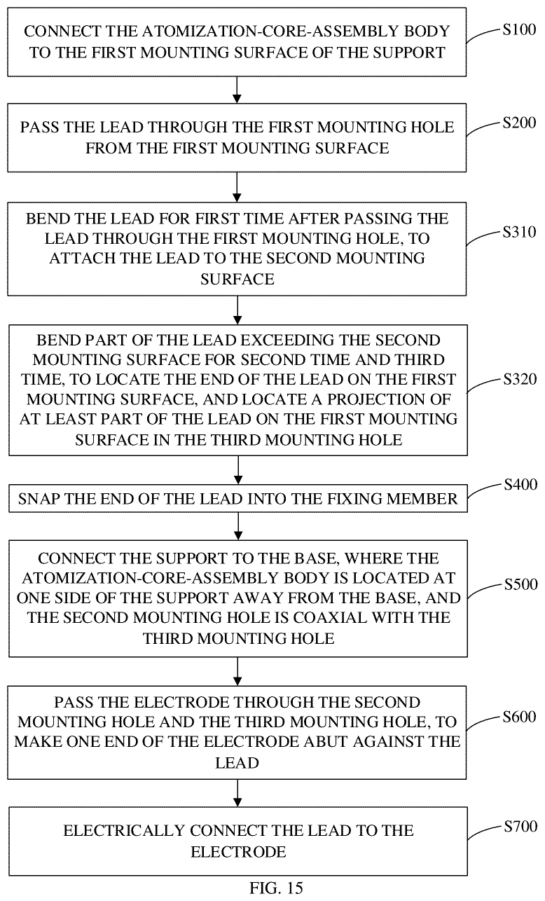

Further, referring to FIG. 15, the atomization device 10 further includes a base 600 and an electrode 700. The support 400 further defines a third mounting hole 440 in a circumferential direction of the first mounting hole 420. The base 600 defines a second mounting hole 601. The fixing member 430 is located on the first mounting surface 411 or the second mounting surface 412. The lead 320 is bend to the first mounting surface 411 or the second mounting surface 412 as follows.

S310, the lead 320 is bent for first time after passing the lead 320 through the first mounting hole 420, to make the lead 320 attach to the second mounting surface 412.

S320, part of the lead 320 exceeding the second mounting surface 412 is bent for second time and third time, to locate the end of the lead 320 on the first mounting surface 411, and locate a projection of at least part of the lead 320 on the first mounting surface 411 in the third mounting hole 440.

After the end of the lead 320 is snapped into the fixing member 430, the method further included the following.

S500, the support 400 is connected to the base 600, where the atomization-core-assembly body 310 is located at one side of the support 400 away from the base 600, and the second mounting hole 601 is coaxial with the third mounting hole 440.

S600, the electrode 700 is passed through the second mounting hole 601 and the third mounting hole 440, to make one end of the electrode 700 abut against the lead 320.

S700, the lead 320 is electrically connected to the electrode 700.

It may be understood that the electrical connection treatment includes ways such as welding, heat stacking, ultrasonic welding, etc., with the purpose of enabling conduction between the lead 320 and the electrode 700.

In the method for assembling the atomization device 10 in embodiments of the present disclosure, the atomization core assembly 300 and the support 400 are integrally mounted first, and then the support 400 is connected to the base 600 step by step, so that the atomization core assembly 300 and the support 400 are uniformly mounted, thereby effectively improving the assembly efficiency and the yield of the atomization core device 10.

After the electrode 700 is passed through the third mounting hole 440 and the second mounting hole 601, the connection strength between the base 600 and the support 400 is further improved by means of the electrode 700. In other words, the electrode 700 can prevent the base 600 and the support 400 from being misplaced with each other, so that the stability of the atomization device 10 is further improved.

In some embodiments, referring to FIG. 1 to FIG. 3, the assembly of the atomization device 10 may include the following. Mount the atomization core assembly 300 to the support 400 first, place liquid absorbent fiber 500 on the base 600, and then mount the support 400 on the base 600. Then, pass the electrode 700 through the base 600, the liquid absorbent fiber 500, and the support 400, to connect electrode 700 to the atomization core assembly 300. Then, insert an elastic injection plug 111 into a housing 100 (which may be a nozzle). Furthermore, sleeve a sealing member 200 on the atomization core assembly 300. Finally, connect the housing 100 to the base 600, so that the housing 100 and the base 600 wrap other components, thereby realizing the assembly of the atomization device 10.

In some embodiments, after the atomization device 10 is used for a long time, the atomized liquid carried in the atomization core assembly 300 will be gradually consumed, and thus it is generally necessary to add the atomized liquid into the atomization device 10, thereby preventing the atomization assembly core from being dry-burnt. In the related art, when the atomized liquid is added into the atomization device 10, due to the relatively large flow rate of the atomized liquid added, the atomized liquid tends to impact the atomization core assembly 300, thereby causing leakage of the atomized liquid.

To solve the described problem, referring to FIG. 1 to FIG. 3 and FIG. 10 to FIG. 12, an atomization device 10 is provided in embodiments. The atomization device 10 includes an atomization core assembly 300, a sealing member 200, and a housing 100. The atomization core assembly 300 is configured to heat atomized liquid. The housing 100 defines a first injection hole 120. The first injection hole 120 allows the atomized liquid to be injected. The atomization core assembly 300 and the sealing member 200 are connected to each other and are located in the housing 100. At least part of the sealing member 200 is located between the atomization core assembly 300 and the first injection hole 120.

Since the sealing member 200 is located between the atomization core assembly 300 and the first injection hole 120, by the method illustrated in FIG. 12, when the user uses an infusion member 20 to inject the atomized liquid into the atomization device 10 through the first injection hole 120, the atomized liquid flowing out of the infusion member 20 cannot directly contact and impact the atomization core assembly 300, but firstly contacts the sealing member 200 and then flows into the atomization core assembly 300.

Therefore, the atomization device 10 in this embodiment can avoid leakage caused by the impact of the atomized liquid to the atomization core assembly 300.

Further, referring to FIG. 1 to FIG. 3 and FIG. 10 to FIG. 12, if the sealing member 200 is completely attached to an outer sidewall of the atomization core assembly 300, it may take a long time for the atomized liquid to contact the atomization core assembly 300, resulting in a decrease in heating efficiency. In this embodiment, at least part of the sealing member 200 is located between the atomization core assembly 300 and the first injection hole 120. An injection gap 240 is defined between the at least part of the sealing member 200 and the outer sidewall of the atomization core assembly 300. The injection gap 240 allows circulation of the atomized liquid. In this case, with the injection gap 240, the atomized liquid can be avoided from impacting the atomized core 300, and the rate at which the atomized liquid contacts the atomization core assembly 300 can be improved.

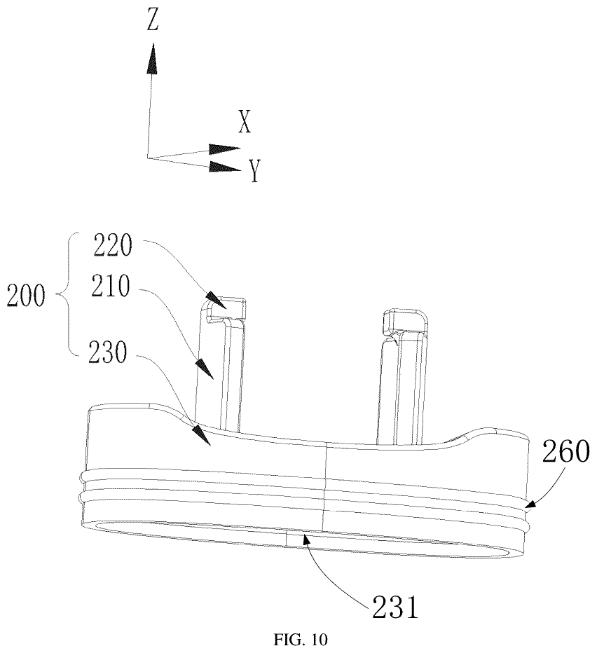

Further, referring to FIG. 10 to FIG. 12, the sealing member 200 includes a limiting portion 210 and a protruding portion 220 connected to each other. The injection gap 240 is defined between the limiting portion 210 and the outer sidewall of the atomization core assembly 300. The protruding portion 220 is located at one end of the limiting portion 210 facing or near the first injection hole 120. The protruding portion 220 protrudes towards the outer sidewall of the atomization core assembly 300 and abuts against the outer sidewall of the atomization core assembly 300. In X direction, the thickness of the protruding portion 220 is less than the thickness of the limiting portion 210, so as to define a communication opening (not marked in the figure) in communication with the injection gap 240. The communication opening allows the atomized liquid to flow into the injection gap 240.

During injection of the atomized liquid into the atomization device 10 in practical use, the atomized liquid may impact the sealing member 200 to result in deformation of the sealing member 200, and thus the effect of avoiding the atomized liquid from impacting the atomization core assembly 300 cannot be realized. In this embodiment, by disposing the protruding portion 220, the protruding portion 220 can prevent deformation of the limiting portion 210 by contacting the outer sidewall of the atomization core assembly 300 when the atomized liquid impacts the sealing member 200.

It may be understood that, in some embodiments, when the sealing member 200 surrounds the sidewall of the atomization core assembly 300, or when part of the sidewall of the atomization core assembly 300 not covered by the sealing member 200 is covered by other components, the atomized liquid can only enter the injection gap 240 through the communication opening, and then enter the interior of the atomization core assembly 300. In this case, the atomized liquid can further be avoided from impacting the atomization core assembly 300. When the atomized liquid is added, the infusion member 20 can be aligned with the communication opening to improve the injection efficiency of the atomized liquid.

Further, referring to FIG. 10, in Y direction, the width of the injection gap 240 is 0.5 mm-1 mm; and/or in Y direction, the thickness of the protruding portion 220 is 1.1 mm-1.5 mm, and the thickness of the limiting portion 210 is 0.5 mm-1 mm; and/or the injection gap 240 gradually increases from the protruding portion 220 in a direction away from the protruding portion 220; and/or the height of the first injection hole 120 is equal to the height of the injection gap 240.

In FIG. 10, a height direction is Z direction, and a width direction is Y direction.

When the width of the injection gap 240 is 0.5 mm-1 mm, the atomized liquid can form a gap liquid-flow phenomenon in the injection gap 240. The liquid flow is caused by a pure pressure difference, that is, the pressure-difference flow. In this case, the too wide injection gap 240 that fails to effectively prevent the atomized liquid from impacting the atomization core assembly 300 can be avoided, and the atomized liquid is also enabled to climb along the injection gap 240. Therefore, it is beneficial for the atomized liquid to enter the interior of the atomization core assembly 300 along the injection gap 240, through a second injection hole 311 on the outer sidewall of the atomization core assembly 300.

In Y direction, the thickness of the protruding portion 220 needs to be larger than the thickness of the limiting portion 210, so that when the protruding portion 220 abuts against the outer sidewall of the atomization core assembly 300, the injection gap 240 can be defined between the limiting portion 210 and the outer sidewall of the atomization core assembly 300. The difference between the thickness of the protruding portion 220 and the thickness of the limiting portion 210 determines the size of the communication opening, that is, determines the rate at which the atomized liquid enters the injection gap 240. Therefore, in the range of the thickness of the protruding portion 220 and the thickness of the limiting portion 210 in the present disclosure, the atomized liquid can easily enter the injection gap 240, and liquid leakage can be avoided, where the liquid leakage is caused by excessive impact applied to the atomization core assembly 300 due to injection of too much atomized liquid at one time.

It can be understood that, the width of the injection gap 240 may be any one of 0.5 mm, 0.6 mm, 0.7 mm, 0.8 mm, 0.9 mm, and 1 mm, or in a range formed by any two of 0.5 mm, 0.6 mm, 0.7 mm, 0.8 mm, 0.9 mm, and 1 mm. The thickness of the protruding portion may be any one of 1 mm, 1.1 mm, 1.2 mm, 1.3 mm, 1.4 mm, and 1.5 mm, or in a range formed by any two of 1 mm, 1.1 mm, 1.2 mm, 1.3 mm, 1.4 mm, and 1.5 mm. The thickness of the limiting portion may be any one of 0.5 mm, 0.6 mm, 0.7 mm, 0.8 mm, 0.9 mm, and 1 mm, or in a range formed by any two of 0.5 mm, 0.6 mm, 0.7 mm, 0.8 mm, 0.9 mm, and 1 mm. Regarding the injection gap, the width of the injection gap and the solvent in the injection gap can be increased by defining a groove on a surface of the limiting portion 210 facing the atomization core body 300. Preferably, when the thickness of the protrusion is 1.3 mm, the thickness of the limiting portion is 0.8 mm, and the width of the injection gap is 0.85 mm, the atomization device 10 has the best performance, where the atomized liquid can easily enter the injection gap 240, and the liquid leakage, caused by excessive impact applied to the atomization core assembly 300 due to injection of too much atomized liquid at one time, can be avoided.

Further, if the injection gap 240 gradually increases from the protruding portion 220 in the direction away from the protruding portion 220, when the user inhales the atomization device 10, the atomized liquid may be moved from bottom to top into the atomization core assembly 300. In this case, the shape of the injection gap 240 can ensure that the space for the atomized liquid to move gradually decreases. In other words, the tensile force of the atomized liquid and the ability of the atomized liquid to adhere to the limiting portion 210 and the atomization core assembly 300 are improved, thereby avoiding the atomized liquid from being unable to be sucked and moved.

Further, if the height of the first injection hole 120 is equal to the height of the injection gap 240, after the user inserts the infusion member 20 into the first injection hole 120, a liquid outlet (not marked in the figure) of the infusion member 20 will be located just above the injection gap 240, thereby facilitating the atomized liquid to enter the injection gap 240 through the communication opening.

Further, referring to FIG. 10 to FIG. 12, the sealing member 200 further includes a sealing-member body 230. The sealing-member body 230 defines a fixing hole 231. The atomization core assembly 300 is located in the fixing hole 231, and is fixedly connected to the sealing-member body 230. The limiting portion 210 is disposed at the periphery of the fixing hole 231.

In this case, the sealing member 200 can be tightly connected to the atomization core assembly 300, so as to prevent the atomization core assembly 300 and the sealing member 200 from slipping relative to each other, thereby preventing the sealing member 200 from being unable to continuously alleviate the impact of the atomized liquid.

Further, referring to FIG. 11 to FIG. 13, the sealing-member body 230 includes a first sealing-member body (not marked in the figure) and a second sealing-member body (not marked in the figure) that are connected to each other. The first sealing-member body is close to an inner wall of the housing 100, and the second sealing-member body is close to the atomization core assembly 300 and is connected to the limiting portion 210. The height of the first sealing-member body is larger than the height of the second sealing-member body.

In this case, the height direction is a direction of a connection line from the center of the base 600 to the center of the atomization core assembly 300, that is, Z direction in FIG. 10. Since the height of the first sealing-member body is larger than the height of the second sealing-member body, the atomized liquid can flow from the inner wall of the housing 100 towards the atomization core assembly 300, so that when the atomization device 10 has less atomized liquid, the atomized liquid can still naturally flow towards the atomization core assembly 300 under the action of gravity.

It can be understood that, as illustrated in FIG. 11 and FIG. 12, the second sealing-member body may have an inclined surface, and in this case, the atomized liquid can smoothly flow along the inclined surface. Alternatively, there may be a height difference between the first sealing-member body and the second sealing-member body, and in this case, the first sealing-member body and the second sealing-member body form a step-like shape, and the atomized liquid can still have a tendency to flow towards the atomization core assembly 300 due to the viscosity and fluidity of the atomized liquid.

Further, referring to FIG. 10 to FIG. 12, there are multiple limiting portions 210 and multiple protruding portions 220, and the multiple limiting portions 210 are in a one-to-one correspondence with the multiple protruding portions 220. The multiple limiting portions 210 are symmetrically distributed in the circumferential direction of the fixing hole 231.

In this case, the limiting portion 210 and the protruding portion 220 can clamp the atomization core assembly 300. Due to the symmetrical distribution of the multiple limiting portions 210 and the multiple protruding portions 220, the atomization core assembly 300 is subjected to equal forces at various positions, so that the stability of the atomization core assembly 300 can be improved.

Further, referring to FIG. 10 to FIG. 12, a first elastic protrusion 250 is disposed on an inner wall of the fixing hole 231. The first elastic protrusion 250 abuts against the outer sidewall of the atomization core assembly 300, so that the atomization core assembly 300 is in an interference fit with the fixing hole 231.

In this case, the interference fit between the atomization core assembly 300 and the fixing hole 231 can further prevent the relative slipping between the atomization core assembly 300 and the sealing member 200.

Further, the first elastic protrusion 250 is an annular protrusion; and/or there are multiple first elastic protrusions 250, and the multiple first elastic protrusions 250 are distributed in an axial direction of the fixing hole 231; and/or a second elastic protrusion 260 is further disposed on an outer sidewall of the sealing-member body 230, and the second elastic protrusion 260 abuts against the inner wall of the housing 100, so that the sealing-member body 230 is in interference fit with the housing 100.

When the first elastic protrusion 250 is an annular protrusion and/or there are multiple first electric protrusions, the outer sidewall of the atomization core assembly 300 is subjected to uniform forces at various positions, and the stability of the atomization core assembly 300 is stronger. Similarly, the second elastic protrusion 260 can strengthen structural strength between the sealing member 200 and the housing 100, and further prevent the sealing member 200 from slipping.

Further, referring to FIG. 3 and FIG. 10 to FIG. 12, the outer sidewall of the atomization core assembly 300 defines a second injection hole 311. The second injection hole 311 allows the atomized liquid to flow into the interior of the atomization core assembly 300 from the injection gap 240. A projection of the limiting portion 210 on the outer sidewall of the atomization core assembly 300 covers at least part of the second injection hole 311.

Generally, the second injection hole 311 allows the atomized liquid to enter the interior of the atomization core assembly 300 from the injection gap 240, so that in order to avoid the atomized liquid from entering the interior of the atomization core assembly 300 directly from the injection gap 240, in the embodiments, the limiting portion 210 covers the second injection hole 311. In this case, if the atomized liquid intends to impact the atomization core assembly 300 and enter the interior of the atomization core assembly 300 directly, the atomized liquid is bound to be buffered by the limiting portion 210. In addition, a material of the limiting portion 210 corresponding to the part of the outer sidewall of the atomization core assembly 300 that does not define the second injection hole 311 can be saved, thereby reducing the production cost of the atomization device 10.

Further, referring to FIG. 1 to FIG. 3 and FIG. 11 to FIG. 12, a width direction of the housing 100 is Y direction in FIG. 1, and a height direction of the housing 100 is Z direction in FIG. 1. The width of the housing 100 is larger than the thickness of the housing 100. Two symmetrically distributed first accommodating cavities (not marked in the figure) and two symmetrically distributed second accommodating cavities (not marked in the figure) are defined between the atomization core assembly 300 and an inner sidewall of the housing 100. The first accommodating cavity is larger than the second accommodating cavity. The injection hole and the limiting portion 210 are both located in the first accommodating cavity.

In practical production of the atomization device 10, the housing 100 of the atomization device 10 may be set in an elliptic shape. In this case, the first injection hole 120 may be defined at one side of the housing 100 away from a central point of the housing 100, that is, one side where the first accommodating cavity is located.

In this case, the atomization core assembly 300 is covered by the housing 100 at both sides of the second accommodation cavity, and the gap between the atomization core assembly 300 and the housing 100 is relatively small. Even if the atomization core assembly 300 defines the second injection hole 311 on a sidewall of the second accommodation cavity, it is difficult for the atomized liquid to impact part of the atomization core assembly 300 corresponding to the second accommodation cavity after the atomized liquid is injected by the infusion member 20. Therefore, it is unnecessary to dispose the protruding portion 220 in the second accommodating cavity, thereby reducing the production cost of the atomization device 10.

Further, referring to FIG. 1 and FIG. 11 to FIG. 12, the housing 100 is further provided with an elastic injection plug 111. The elastic injection plug 111 includes a fixing portion 112 and a flipping portion 113. The fixing portion 112 is fixedly connected to the housing 100. The flipping portion 113 is connected to the fixing portion 112 and is detachably connected to the first injection hole 120, and is used for reciprocating flipping to block or communicate with the first injection hole 120.

In this case, in the atomization device 10 in this embodiment, the elastic injection plug 111 can be flipped, so that the elastic injection plug 111 is deformed to block or communicate with the first injection hole 120. Thus, the injection efficiency of the atomized liquid in the atomization device 10 is improved.

When the atomization device 10 is used, the atomized liquid is heated to form aerosol, and the condensate formed by condensation of the atomized liquid and the aerosol in the atomization device 10 will generally accumulate at the bottom of the atomization device 10. In the related art, the random accumulation and flow of the atomized liquid and the condensate often results in liquid leakage of the atomization device 10, which affects the experience of the user and also reduces the service life of the atomization device 10.

A liquid reservoir 610 may be a cavity or a groove separately defined by the base 600, or a cavity defined by the liquid reservoir 610 and other components in the atomization device 10 together.

To solve the described technical problem, reference can be made to FIG. 1 to FIG. 4 and FIG. 10 to FIG. 13. An atomization device 10 is provided in an embodiment of the present disclosure. The atomization device 10 includes an atomization core assembly 300, a support 400, and a base 600. A flow channel 312 is defined in the atomization core assembly 300. The flow channel 312 allows flow of liquid. The support 400 includes a support body 410 and a guiding portion 460. The guiding portion 460 protrudes from the support body 410 and is connected to the bottom of the atomization core assembly 300. An outer sidewall of the guiding portion 460 has a guiding surface 461. The guiding surface 461 is an inclined surface or an arc surface. The base 600 defines a liquid reservoir 610. Part of the support body 410 is located in the liquid reservoir 610. The guiding surface 461 and a surface of the support body 410 facing the atomization core assembly 300 defines a guiding channel 470. Two ends of the guiding channel 470 are respectively in communication with the flow channel 312 and the liquid reservoir 610.

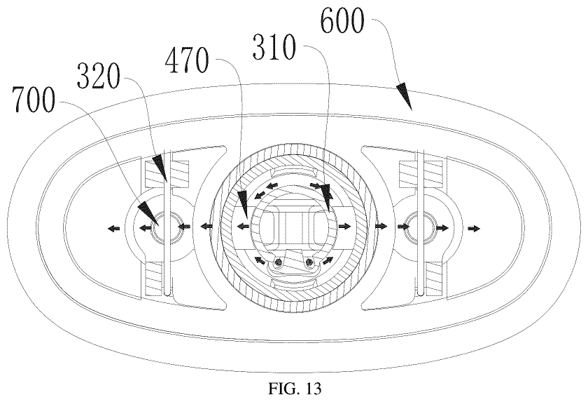

The directions indicated by arrows in FIG. 4, FIG. 11, and FIG. 13 are flow directions of the atomized liquid and the condensate. It can be seen from the figures that the atomized liquid and the condensate flow from top to bottom inside the atomization core assembly 300 onto the guiding surface 461, and then since the guiding surface 461 is the inclined surface or the arc surface, the guiding surface 461 can guide the atomized liquid and the condensate to smoothly flow from the guiding portion 460 to a side edge of the support body 410 under the action of gravity. Since part of the support body 410 is located in the liquid reservoir 610, the thermal material to-be-heated and the condensate can smoothly flow to the side edge of the support body 410 and then flow from the side edge of the support body 410 into the liquid reservoir 610. Therefore, in this embodiment, the purpose of gathering the atomized liquid and the condensate in the liquid reservoir 610 is realized, thereby successfully avoiding the atomized liquid and the condensate from randomly accumulating and flowing in the atomization device 10.

Further, referring to FIG. 3 and FIG. 11 to FIG. 12, liquid absorbent fiber 500 is disposed in the liquid reservoir 610. The guiding channel 470 is in communication with the liquid absorbent fiber 500.

The liquid absorbent fiber 500 includes components such as liquid absorbent cotton, and can absorb the atomized liquid and the condensate. In this case, the liquid absorbent fiber 500 can prevent the atomized liquid and the condensate from overflowing when the atomization device 10 shakes, thereby further preventing leakage of the atomized liquid and the condensate.

Further, referring to FIG. 3, FIG. 11, and FIG. 12, a fixing groove is defined at the bottom of the liquid reservoir 610. The liquid absorbent fiber 500 includes first liquid-absorbent-fiber 510 and second liquid-absorbent-fiber 520 stacked with the first liquid-absorbent-fiber 510. The second liquid-absorbent-fiber 520 is snapped into the fixing groove. The first liquid-absorbent-fiber 510 is snapped between the second liquid-absorbent-fiber 520 and a top wall of the liquid reservoir 610.

In this case, the absorption amount of the atomized liquid and the condensate can be improved by means of the double-layer liquid absorbent fiber 500. In addition, the first liquid-absorbent-fiber 510 is snapped between the second liquid-absorbent-fiber 520 and the top wall of the liquid reservoir 610, so that there is no need to additionally dispose a structure to fix the first liquid-absorbent-fiber 510. Therefore, the inner space of the atomization device 10 is fully used, the space utilization rate of the atomization device 10 is further improved, and the production cost of the atomization device 10 is reduced.

Further, referring to FIG. 11 to FIG. 12, the guiding channel 470 is in communication with the first liquid-absorbent-fiber 510; and/or an outer sidewall of the support body 410 and sidewalls of both the first liquid-absorbent-fiber 510 and the second liquid-absorbent-fiber 520 defines a liquid absorbent gap.

The atomized liquid and the condensate stored in the liquid reservoir 610 can climb up to the interior of the atomization core assembly 300 again under the inhalation of the user, and are heated for the second time to form aerosol. If the liquid to-be-heated is stored in the second liquid-absorbent-fiber 520 but not in the first liquid-absorbent-fiber 510, it is difficult for the atomized liquid and the condensate to continuously climb into the atomization core assembly 300.

In the embodiments, since the guiding channel 470 is in communication with the first liquid-absorbent-fiber 510, after the atomized liquid and the condensate flow into the guiding portion 460 from the atomization core assembly 300, and flow out through the side edge of the support body 410, the atomized liquid and the condensate flow to the first liquid-absorbent-fiber 510 first. After the first liquid-absorbent-fiber 510 is fully stored, the atomized liquid and the condensate gradually flow to the second liquid-absorbent-fiber 520. Therefore, a situation where the first liquid-absorbent-fiber 510 does not store liquid while the second liquid-absorbent-fiber 520 stores liquid can be avoided.

Further, referring to FIG. 11 to FIG. 13, the second liquid-absorbent-fiber 520 is located between the support body 410 and the base 600. The support body 410 defines a guiding hole. The guiding hole extends through the support body 410, and has one end in communication with an upper surface of the second liquid-absorbent-fiber 520.

In some embodiments, the support body 410 may define a guiding hole (not marked in the figure). The storage of the atomized liquid and the condensate can be speeded up through the guiding hole.

Further, referring to FIG. 7 to FIG. 13, the support 400 further has a first sidewall 480 and a second sidewall 490. The guiding portion 460, the first sidewall 480, the second sidewall 490, and an upper surface of the support body 410 cooperatively define the guiding channel 470.

In this case, the guiding channel 470 is in the shape of a sliding groove, and can avoid the atomized liquid and the condensate from flowing from the atomization core assembly 300 to a portion where the guiding channel 470 is not defined. In other words, the atomized liquid and the condensate are limited to flow in a certain shape and path, thereby further preventing leakage of the atomized liquid and the condensate

Further, referring to FIG. 11 to FIG. 12, the atomization device 10 further includes a liquid absorbent member (not illustrated in the figure). The liquid absorbent member has one end located in the guiding channel 470, and the other end located in the flow channel 312.

In some cases, the user needs to inhale the atomized liquid and the condensate in the liquid reservoir 610 or the guiding channel 470 into the interior of the atomization core assembly 300, and flowing of liquid needs to depend on solids. Therefore, in this embodiment, the liquid absorbent member is additionally disposed, one end of the liquid absorbent member is located in the guiding channel 470, and the other end of the liquid absorbent member is located in the flow channel 312. In this case, the liquid can climb along the liquid absorbent member, thereby entering the flow channel 312 from the guiding channel 470.

Further, referring to FIG. 11 to FIG. 13, compared with the top of the guiding surface 461, the bottom of the guiding surface 461 is closer to the side edge of the support body 410. Since the bottom of the guiding surface 461 is closer to the side edge of the support body 410, when the guiding surface 461 is an inclined surface, the guiding surface 461 has a shape similar to a side surface of a regular trapezoid, so that the atomized liquid or the condensate can naturally flow towards the side edge of the support body along the surface of the support body under the action of gravity, and then enter the liquid reservoir 610. When the guiding surface is a curved surface, the surface of the support body is formed to be concave towards the center of the support body 410 as illustrated in FIG. 10, which can also guide the atomized liquid or the condensate to naturally flow into the liquid reservoir 610 under the action of gravity.

Further, referring to FIG. 11 to FIG. 12, the atomization device 10 further includes a housing 100 and a sealing member 200. The base 600 is connected to the bottom of the housing 100. The sealing member 200 is located in the housing 100 and is connected to an upper surface of the base 600. The sealing member 200 and the upper surface of the base 600 define a liquid reservoir 610.

In this case, the liquid reservoir 610 is cooperatively defined by the sealing member 200 and the base 600. The size of the liquid reservoir can vary with a distance between the sealing member 200 and the base 600.

Further, referring to FIG. 4 to FIG. 6 and FIG. 10 to FIG. 13, a first mounting hole 420 is disposed in the middle of the guiding portion 460. The bottom of the atomization core assembly 300 covers the first mounting hole 420. The atomization core assembly 300 further includes a lead 320. The lead 320 passes through the first mounting hole 420.

In this case, the atomization core assembly 300 covers the first mounting hole 420, so that the lead 320 can be avoided from being bumped, and the atomized liquid and the condensate can be avoided from flowing into the first mounting hole 420.

Further, an inhalation channel 313 is defined in the top of the atomization core assembly 300, and allows the aerosol to pass through. The inhalation channel 313 is in communication with the flow channel 312 and the external environment. The circulation area of the inhalation channel 313 gradually decreases in a direction from the flow channel 312 to the external environment.

When the atomization core assembly 300 in the atomization device 10 heats the atomized liquid to produce aerosol, the aerosol will flow out to the external environment through the inhalation channel 313. Part of the aerosol will condense to form condensate due to the contact with the sidewall of the inhalation channel 313 or the temperature decrease. In this embodiment of the present disclosure, the flow area of the inhalation channel 313 gradually decreases, so that the volume of the aerosol is reduced and compressed in the outward flow process, and the flow rate of aerosol in contact with the sidewall increases, so that the condensate is more easily formed, thereby realizing the repeated use of the atomization device 10.

It can be understood that the atomization device in the described embodiments includes, but is not limited to, devices such as aerosol generating device, an aromatherapy machine, a medicine atomizer, a fire protection sprinkler system, a cleaning device, an irrigation device, a cosmetic device, and a laboratory solute extraction device.

The embodiments of the present disclosure are introduced above in details. The principles and implementations of the present disclosure are described by using specific examples herein, and the descriptions of the foregoing embodiments are merely intended to help understand the method and the core idea of the method of the present disclosure. Meanwhile, for those skilled in the art, there will be changes in the specific implementations and application scope based on the ideas of the present disclosure. In summary, the content of this specification may not be construed as a limitation of the present disclosure.

Apparently, the embodiments described above are only some embodiments of the present disclosure, instead of all of them. The accompanying drawings show preferred embodiments of the present disclosure, but do not limit the protection scope of the present disclosure. The present disclosure may be implemented in many different forms. On the contrary, the purpose of providing these embodiments is to make the disclosure of the present disclosure be understood more thoroughly and comprehensively. Although the present disclosure has been described in detail with reference to the above embodiments, those skilled in the art can still modify the technical solutions described in the above specific embodiments, or equivalently replace some of the technical features. All the equivalent structures, which are made using the contents of the description and the accompanying drawings of the present disclosure, and are directly or indirectly used in other related technical fields, still fall within the protection scope of the present disclosure.

Although the embodiments of the present disclosure have been shown and described, it would be appreciated by those skilled in the art that changes, modifications, combinations, replacements, and variations may be made to these embodiments without departing from the principle and spirit of the present disclosure, and the scope of the present disclosure is defined by the claims and their equivalents.

What is claimed is:

1. An atomization device, comprising:
an atomization core assembly comprising an atomization-core-assembly body and a lead connected to the atomization-core-assembly body at a bottom of the atomization-core-assembly body;
a support having a first mounting surface and a second mounting surface opposite to the first mounting surface, and defining a first mounting hole extending through the first mounting surface and the second mounting surface; and
a fixing member connected to the support and configured to fix an end of the lead;
wherein the atomization-core-assembly body is connected to the first mounting surface, the lead passes through the first mounting hole and is bent to the first mounting surface or the second mounting surface, and the end of the lead is snapped into the fixing member.

2. The atomization device of claim 1, wherein the fixing member comprises a connecting portion and a bending portion;
the connecting portion has one end connected to the support, and the other end connected to the bending portion; and
a bending gap is defined between the bending portion and the support, the bending portion defines a limiting groove on a surface of the bending portion facing the bending gap, and the end of lead is snapped into the limiting groove.

3. The atomization device of claim 2, wherein the bending portion has a chamfer at one side of the bending portion away from the connecting portion, and the chamfer extends to the bending gap; or
the bending portion has a rounded corner at one side of the bending portion away from the connecting portion, and the rounded corner extends to the bending gap.

4. The atomization device of claim 1, wherein a sidewall of the first mounting hole defines a limiting notch, the limiting notch matches the lead in shape and size, and at least part of the lead is snapped into the limiting notch.

5. The atomization device of claim 4, wherein the fixing member is implemented as at least two fixing members, the lead is implemented as at least two leads, the limiting notch is implemented as at least two limiting notches, the number of the at least two fixing members is equal to the number of the at least two leads, and the number of the at least two limiting notches is equal to the number of the at least two leads; and
the at least two fixing members are uniformly distributed in a circumferential direction of the first mounting hole, and the at least two limiting notches are uniformly distributed in the circumferential direction of the first mounting hole.

6. The atomization device of claim 1, wherein an outer sidewall of the support defines an avoidance notch, and at least part of the lead is accommodated in the avoidance notch and is bent to the first mounting surface.

7. The atomization device of claim 1, further comprising a base and an electrode, wherein the support is connected to the base, and the atomization-core-assembly body is located at one side of the support away from the base; and
the base defines a second mounting hole, and the electrode passes through the second mounting hole, and has one end connected to the lead.

8. The atomization device of claim 7, wherein the lead is bent to the first mounting surface or the second mounting surface, the support further defines a third mounting hole in a circumferential direction of the first mounting hole, and a projection of at least part of the lead on the first mounting surface or the second mounting surface is located in the third mounting hole; and
the second mounting hole is coaxial with the third mounting hole, and the electrode passes through the third mounting hole.

9. The atomization device of claim 1, further comprising a sealing member and a housing, wherein the housing defines a first injection hole, the first injection hole allows atomized liquid to be injected, the atomization core assembly and the sealing member are connected to each other and are located in the housing, and at least part of the sealing member is located between the atomization core assembly and the first injection hole.

10. The atomization device of claim 9, wherein the sealing member comprises a limiting portion and a protruding portion connected to each other, an injection gap is defined between the limiting portion and an outer sidewall of the atomization core assembly, the protruding portion is located at one end of the limiting portion facing or near the first injection hole, the protruding portion protrudes towards the outer sidewall of the atomization core assembly and abuts against the outer sidewall of the atomization core assembly.

11. The atomization device of claim 10, wherein in a width direction of the housing, a width of the injection gap 240 is 0.5 mm-1 mm; and/or in the width direction of the housing, a thickness of the protruding portion 220 is 1.1 mm-1.5 mm, and a thickness of the limiting portion 210 is 0.5 mm-1 mm.

12. The atomization device of claim 10, wherein the sealing member further comprises a sealing-member body, the sealing-member body defines a fixing hole, the atomization core assembly is located in the fixing hole and is fixedly connected to the sealing-member body, and the limiting portion is disposed at a periphery of the fixing hole.

13. The atomization device of claim 12, wherein the limiting portion is implemented as a plurality of limiting portions, the protruding portion is implemented as a plurality of protruding portions, the plurality of limiting portions are in a one-to-one correspondence with the plurality of protruding portions, and the plurality of limiting portions are symmetrically distributed in a circumferential direction of the fixing hole.

14. The atomization device of claim 11, wherein a first elastic protrusion is disposed on an inner wall of the fixing hole, and the first elastic protrusion abuts against the outer sidewall of the atomization core assembly; wherein
the first elastic protrusion is an annular protrusion; and/or the first elastic protrusion is implemented as a plurality of first elastic protrusions, and the plurality of first elastic protrusions are distributed in an axial direction of the fixing hole.

15. The atomization device of claim 14, wherein a second elastic protrusion is disposed on an outer sidewall of the sealing-member body, and the second elastic protrusion abuts against an inner wall of the housing.

16. The atomization device of claim 11, wherein an outer sidewall of the atomization core assembly defines a second injection hole, the second injection hole allows the atomized liquid to flow into an interior of the atomization core assembly from the injection gap, and a projection of the limiting portion on the outer sidewall of the atomization core assembly covers at least part of the second injection hole.

17. The atomization device of claim 10, wherein the housing is further provided with an elastic injection plug, the elastic injection plug comprises a fixing portion and a flipping portion, the fixing portion is fixedly connected to the housing, the flipping portion is connected to the fixing portion and is detachably connected to the first injection hole, and the flipping portion is used for reciprocating flipping to block or communicate with the first injection hole.

18. The atomization device of claim 7, wherein a flow channel is defined in the atomization core assembly, the support comprises a support body and a guiding portion, the guiding portion protrudes from the support body and is connected to a bottom of the atomization core assembly, an outer sidewall of the guiding portion has a guiding surface, the guiding surface is an inclined surface or an arc surface; and
the base defines a liquid reservoir, part of the support body is located in the liquid reservoir, the guiding surface and a surface of the support body facing the atomization core assembly defines a guiding channel, and two ends of the guiding channel are respectively in communication with the flow channel and the liquid reservoir.

19. A method for assembling an atomization device, applied to an atomization device, wherein the atomization device comprises:
an atomization core assembly comprising an atomization-core-assembly body and a lead connected to the atomization-core-assembly body at a bottom of the atomization-core-assembly body;
a support having a first mounting surface and a second mounting surface opposite to the first mounting surface, and defining a first mounting hole extending through the first mounting surface and the second mounting surface; and
a fixing member connected to the support and configured to fix an end of the lead;
wherein the atomization-core-assembly body is connected to the first mounting surface, the lead passes through the first mounting hole and is bent to the first mounting surface or the second mounting surface, and the end of the lead is snapped into the fixing member; wherein
the method comprises:
connecting the atomization-core-assembly body to the first mounting surface of the support;
passing the lead through the first mounting hole from the first mounting surface;
bending the lead to the first mounting surface or the second mounting surface; and
snapping the end of the lead into the fixing member.

20. The method for assembling the atomization device of claim 19, wherein the atomization device further comprises a base and an electrode, the support further defines a third mounting hole in a circumferential direction of the first mounting hole, the base defines a second mounting hole, and the fixing member is located on the first mounting surface or the second mounting surface;
bending the lead to the first mounting surface or the second mounting surface comprises:
bending the lead for first time after passing the lead through the first mounting hole, to attach the lead to the second mounting surface; and
bending part of the lead exceeding the second mounting surface for second time and third time, to locate the end of the lead on the first mounting surface, and locate a projection of at least part of the lead on the first mounting surface in the third mounting hole;
the method further comprises:
after snapping the end of the lead into the fixing member,
connecting the support to the base, wherein the atomization-core-assembly body is located at one side of the support away from the base, and the second mounting hole is coaxial with the third mounting hole;
passing the electrode through the second mounting hole and the third mounting hole, to make one end of the electrode abut against the lead; and
electrically connecting the lead to the electrode.
